(19) United States
(12) Patent Application Publication
(10) Pub. No.: US 2003/0226116 A1
(43) Pub. Date: Dec. 4, 2003

(54) Method and system for implementing a historical buffer

(76) Inventors: Katie Kuwata, Oceanside, CA (US); William Su, Corona, CA (US); Truc Nguyen, San Diego, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/383,409

(22) Filed: Mar. 7, 2003

Related U.S. Application Data
(60) Provisional application No. 60/362,834, filed on Mar. 8, 2002.

(51) Int. Cl. G06F 15/00

(52) U.S. Cl. 715/530

(57) ABSTRACT

The present invention provides a method and system for implementing a pointer-based historical buffer. The historical buffer system comprises a plurality of information or description files for storing information about files that are edited, in addition to files for storing information relating to changes made to a document and to locations of temporary files relating to the document. In addition, the system employs temporary storage which is preferably deleted upon session termination.

### CROSS-REFERENCE TO RELATED APPLICATIONS

This application claims the benefit of priority from U.S. Provisional Application 60/362,834 filed Mar. 8, 2002.

### BACKGROUND OF THE INVENTION

This invention pertains generally to resource management in a session-based embedded web server system, and more particularly to a method and system for implementing a pointer-based historical buffer mechanism in a session-based embedded web server system.

When users edit documents or groups of documents in an embedded server environment, their changes are typically saved in a historical or undo buffer so that a user can back out of a previous change and restore the content of a document. However, embedded servers generally have limited memory and storage resources. Implementing a historical or undo buffer requires saving a plurality of changes, which generally requires a large buffer storage space to store data and generally consumes significant processing time to transfer edited contents to and from the historical or undo buffer. When document data is in raster image format, as when a controller of a digital imaging device (“DID”) functions as an embedded server, the storage requirement for an undo buffer is particularly large and the negative impact on server processing performance is even more severe than when document data is in non-raster image format. This is due to the fact that raster image files are large files that require significant storage space. Consequently, the implementation of image manipulation undo functionality requires a large historical or undo buffer.

Digital imaging devices (“DID”) are complex machines that often perform a plurality of functions. DIDs suitably include devices such as printers, fax machines, scanners, copiers, multi-functional peripherals (“MFPs”), and other like peripheral devices. DIDs are suitably connected to a network or directly to computer. In addition, DIDs are also suitably servers, with all the necessary hardware and software to ensure proper operation of the server as will be appreciated by one skilled in the art. A DID server is also suitably a server of any type, including a web server, an embedded server, a database server, etc. as will be appreciated by one skilled in the art.

Because multiple users have access to an embedded server and because each user can run concurrent multiple sessions with the embedded server, such as a DID, a separate historical or undo buffer is generally created for each session and each user. Consequently, transferring documents to storage in multiple historical or undo buffers requires significant processing time and storage space. In particular, when an embedded server is a controller on a DID, this additional storage space and server time required to implement a plurality of historical or undo buffers decreases the efficiency of the DID because the processing time and storage space required to implement the historical or undo buffers cannot be used for document processing and printing.

There are a variety of methods known in the art for improving processor performance in servers, especially servers with multiple processors. For example, symmetric multi-processing (“SMP”) has become the de facto standard for multi-processor hardware architectures. Several highly popular operating systems (“OS”) incorporate support for SMP. The basic abstraction of an SMP system is a Multi-Threaded Environment (“MTE”), which is provided by the OS without regard to the actual number of processors running. Therefore, when software is written to make use of a MTE, one can achieve a performance improvement whether or not the SMP hardware platform contains multiple processors.

However, even though improved processor performance can be achieved through the use of SMP, it is always preferable to decrease required resources, both in processing and storage. Therefore, it would be preferable if there were an improved method of providing a historical buffer that uses fewer resources.

### SUMMARY OF THE INVENTION

In accordance with the present invention, there is provided a method and system for implementing an historical buffer that uses fewer resources.

Further, in accordance with the present invention, there is provided a method and system for maintaining a pointer-based historical buffer for edits made to a document.

Still further, in accordance with the present invention there is provided a method and system for implementing a pointer based historical buffer. The method and system comprises the steps of and the means adapted for storing of data representative of an editable, electronic document in a selected storage area; communicating data for generating a display of the electronic document to an associated display device; receiving document modification data representative of a desired modification operation to be performed on the electronic document; storing pointer information associated with received modification data in a pointer memory; incrementing a point value storage area of pointer information in accordance with each received modification data; performing an edit to the electronic document in accordance with received document modification data; associating each received document modification data with a pointer value associated therewith; and storing at least a portion of the electronic document in a form prior to the most recent modification thereof in a historical document storage area.

In another embodiment, the method and system further comprise the steps of and the means adapted for receiving an undo command to selectively undo at least one previous edit; and selectively reversing edits to the electronic document by accessing the electronic documents stored in the historical data storage means in accordance with an associated pointer value.

These and other aspects of the present invention will be understood by one of ordinary skill in the art upon reading and understanding the specification.

### DESCRIPTION OF THE FIGURES

FIG. 1 is a flow chart representing the general process for creating the elements for maintaining a historical buffer according to the present invention;

FIG. 2 is a flow chart representing the general procedure for storing selected information upon an edit to a document according to the present invention;

FIG. 3 is a flow chart representing the procedure for executing an undo command according to the present invention; and

FIG. 4 is a system diagram illustrating a system for maintaining a historical undo buffer in a network environment in accordance with the present invention.

### DETAILED DESCRIPTION OF THE INVENTION

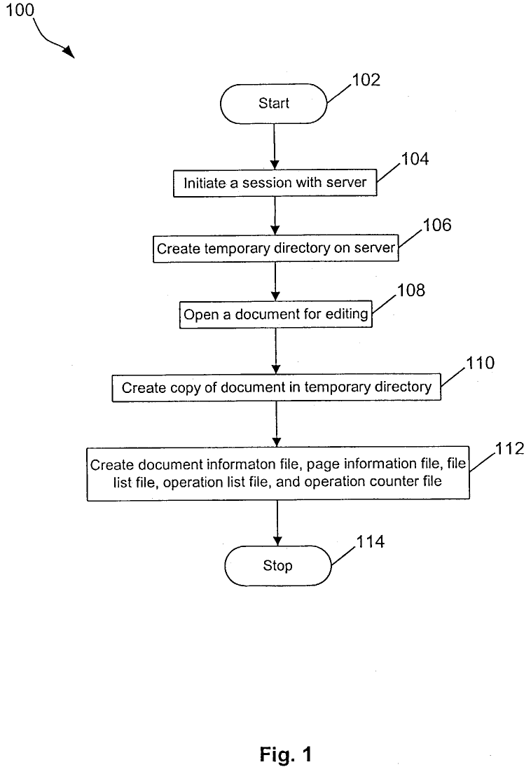

Turning now to FIG. 1, a flowchart flow chart representing the general process for creating the elements for maintaining a historical buffer according to the present invention is provided. The general flow 100 commences at start block 102 and continues to process block 104. At process block 104, a session is initiated, preferably by a user. Progression then flows to process block 106 wherein the server creates a temporary directory for storage of historical buffer information. Preferably, the temporary directory is session-based storage such that when the session ends, the directory and its contents are deleted. Flow continues to process block 108 wherein a document is opened for editing. Flow progresses to process block 110 where a copy of at least one file comprising information about the opened document is copied to the temporary directory. Progression then continues to process block 112 where a plurality of files are created and stored in the temporary directory. Preferably, the created files comprise at least the following: a document information file, at least one page information file, and a file list file. Flow then continues to termination block 114.

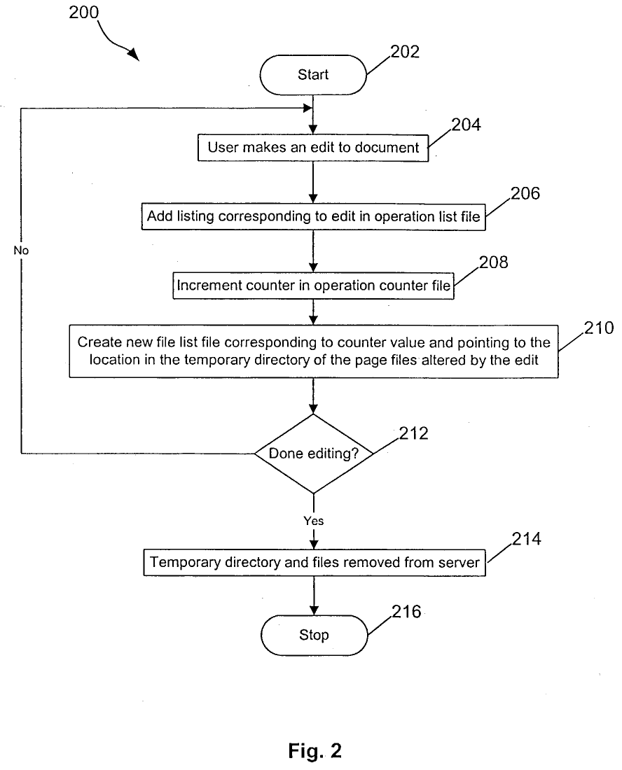

Turning now to FIG. 2, a flowchart is provided representing the general procedure for storing historical information in response to an edit to a document according to the present invention. The general flow 200 commences at start block 202 and continues to process block 204 wherein an edit is made to a document. The edit is suitably made through any known means, such as by a user or by automation procedures. At process block 206, a listing corresponding to the edit made to the document at process block 204 is added to the operation list file. Flow continues to process block 208 where the counter in the operation counter file is incremented. Flow progresses to process block 210 where a new file list file is created corresponding to the incremented counter and pointing to a location in the temporary directory wherein the copies of the edited image (page) files are stored. Progression then continues to decision block 212 where a determination is made whether there are any additional edits to be made.

A positive determination at decision block 212 causes progression to flow back to process block 204 wherein another edit is made to the document. A negative determination at decision block 212 causes progression to process block 214 wherein the temporary directory and files stored therein are removed from the server. Flow then continues to termination block 216.

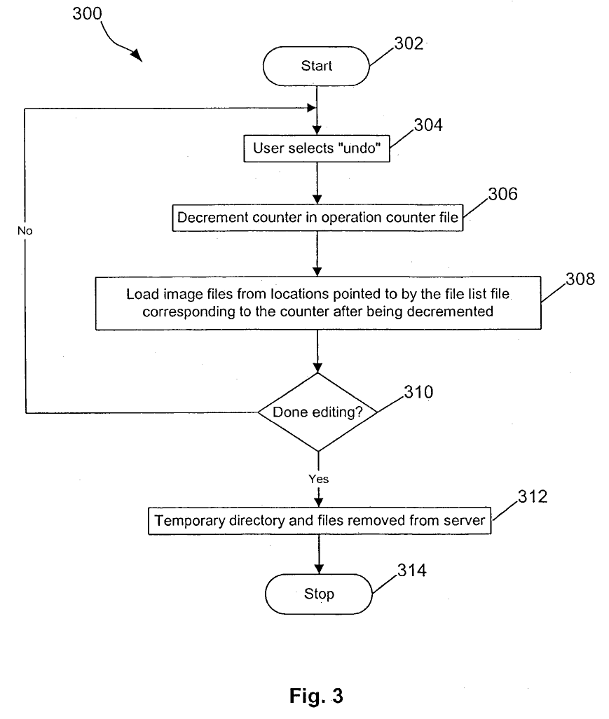

Turning now to FIG. 3, a flow chart is provided representing the procedure for executing an undo command according to the present invention. The general flow 300 commences at start block 302 and continues to process block 304. At process block 304, an undo command is executed. The undo command is suitably executed by a user, such as by selecting “undo” from a menu. The command is also suitably executed through automation. Progression then flows to process block 306 wherein a counter in the operation counter file is decremented. Flow continues to process block 308 where image files are loaded. The locations from which the image files are loaded are preferably referenced in the file list file. In other words the file list file corresponding to the decremented counter points to the locations of the image files. Flow then progresses to decision block 310 where a determination is made whether there are any additional edits to be made.

A positive determination at decision block 310 causes progression to flow back to process block 304 wherein another edit is made to the document. A negative determination at decision block 310 causes progression to process block 312 wherein the temporary directory and files stored therein are removed from the server. Flow then continues to termination block 314.

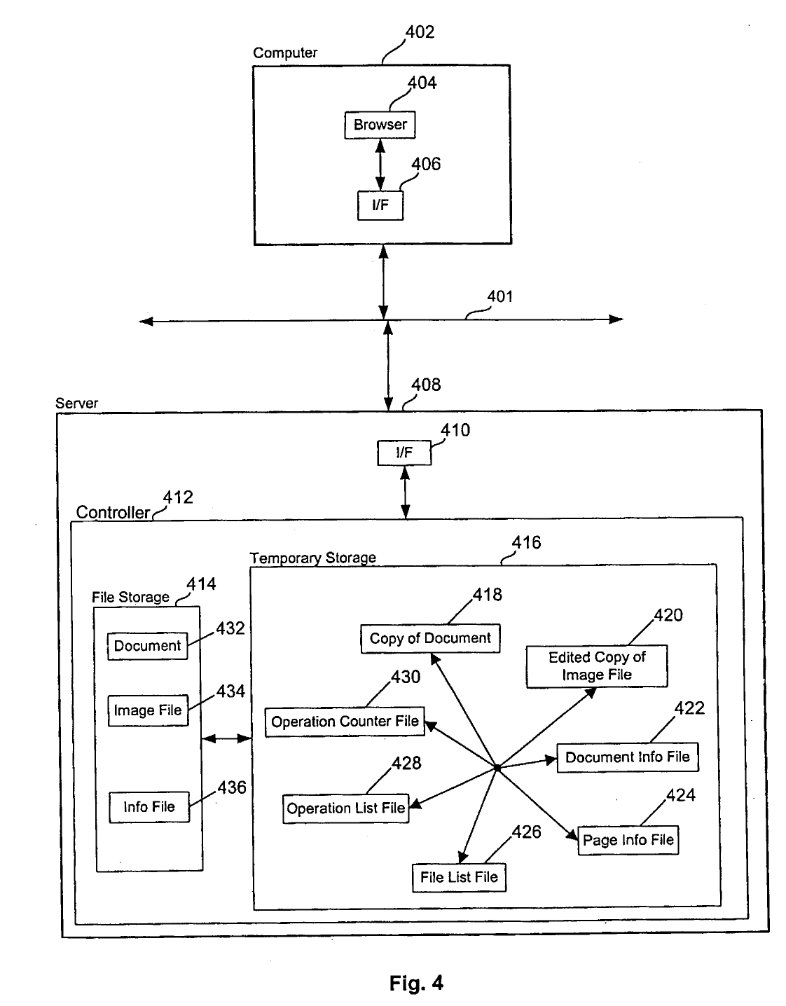

Turning now to FIG. 4, an illustration of a system for maintaining an historical buffer in a network environment in accordance with the present invention is provided. The network 400 is illustrative of a LAN or WAN environment in which a preferred embodiment is provided, such as a packet-switched TCP/IP-based global communication network. Connected to network 400 are a computer 402 and a server 408. The network 400 is suitably any network and is suitably comprised of physical and transport layers such as illustrated by a myriad of conventional data transport mechanisms like Ethernet, Token-Ring™, 802.11(b), or other wire-based or wireless data communication mechanisms as will be apparent to one of ordinary skill in the art. The server 408 is in data communication with a data transport system 401 through a network interface 410. The data transport system 401 is also placed in data communication with the computer 402 through network interface 406. Thus, a data path between the server 408 is in shared data communication with computer 402.

The computer 402 is suitably any type of computer, but is preferably a PC running any operating system, such as Windows NT, Windows 2000, Windows XP, Unix, Linux, Macintosh or other operating system. The computer 402 is preferably configured to interact with Server 408 as will be appreciated by one who is skilled in the art. It should be noted that the computer 402 is suitably a thick client or a thin client, additional server(s), personal digital assistant (“PDA”), or any equipment capable of interacting with server 402 to send and receive data. Preferably, the computer 402 is equipped with a browser software program 404, such as Netscape or Internet Explorer, and a network interface 406.

The server 408 is suitably any device that is capable of providing shared access to files as will be appreciated to one of ordinary skill in the art. As such, the server 408 suitably runs on any operating system as will be appreciated by those skilled in the art. Preferably, the server 408 is a networked MFP, or an MFP connected to a computer. The server 408 suitably comprises a network interface 410, and controller 412. The controller 412 suitably comprises file storage 414 and temporary storage 416. The server 412 storage 414 and 416 preferably comprises at least one hard disk and random access memory (“RAM”). Stored in file storage 414 is at least one document 432 and at least one image (page) file 434. Also suitably stored in file storage 414 is at least one information file 436 comprising information about the at least one document 432 and the at least one image file 434. The controller 412 preferably acts as a fully functional server with the necessary hardware and software that ensure proper operation of the server 408 as will be appreciated by one skilled in the art. In the presently preferred embodiment, the computer 402 and server 408 form an embedded web server system.

In the presently preferred embodiment, a user begins a session. Each session is suitably a lasting connection between a user at a computer 402 and the server 408, usually involving the exchange of many packets between the computer 402 and the server 408. A session is typically implemented as a layer in a network protocol (e.g. telnet, FTP). The user suitably has an ID, which is unique to each user, for identification and authentication. In addition, each session suitably has a session ID, which is unique to each session. A user suitably initiates a session through network interface 406, across data transport network 400, through network interface 410 and to the controller 412. When a session is started, the controller 412 preferably creates temporary storage 416, which is preferably a temporary directory 416. The name of temporary directory 416 is preferably associated with at least one of the session ID and/or user ID.

A user suitably opens a document 432 that is preferably stored in file storage 414 on the server 412 or on storage external storage accessible by both the server 408 and the computer 402 via data transport system 400. Upon opening the document 432, a copy of the document 418 is suitably stored in temporary file storage. The copy of document is suitably stored in the temporary directory 416 or in other temporary storage. In the presently preferred embodiment, the document 432 is an image document or file comprising images, which suitably is comprised of a plurality of pages. Preferably, each page of the document 432 is also stored on file storage 414 as an image file 434.

When a document 432 is opened, at least one information file 436 is suitably copied from file storage 414 to the temporary directory 416. In the presently preferred embodiment, a document information file 436, 422 comprising information about the opened document is copied to the temporary directory 416. It should be noted that information file 422 is also suitably created, rather than copied, when the copy of document 418 is stored in the temporary directory. The information stored in document information file 422 suitably comprises property information such as document type, name, location of the corresponding document 432 on file storage 414, file format, and the number of pages in the document 432. In the presently preferred embodiment, the document information file 422 is an markup language based document, and is preferably an extensible markup language (“XML”) file, but any suitable file format is contemplated for information storage, such as text files, flat files, database files, etc. as will be appreciated by one who is skilled in the art. The format of the document information file 422 of the presently preferred embodiment is illustrated below:

<?xml version=‘1.0’ encoding=‘UTF-8’?>
<!--DOCTYPE docinfo SYSTEM “docinfo.dtd”-->
<docinfo>
<doc>

<name>readme tac</name>
<path>/pbfolder/public</path>
<format>PNG</format>
<totalpage>5</totalpage>

In addition, at least one page information file 424 comprising information about an image file 434 representing a page of the document 432 is suitably copied to the temporary directory 416. Again, it should be noted that page information file 424 is also suitably created, rather than copied, when the copy of document 418 is stored in the temporary directory. The information stored in document information file 422 suitably comprises property information such as the page number, file format, filename, and file location. Preferably, a page information file 424 exists for each page of the document 432. Therefore, for a five-page document 432, there will preferably be five image files 434 stored on file storage 414 and five page information files 424 stored in temporary storage 416. In the presently preferred embodiment, the page information file 424 is also an “XML” document. The format of the page information file 424 of the presently preferred embodiment is illustrated below:

<?xml version=‘1.0’ encoding=‘UTF-8’ ?>
<!--DOCTYPE docinfo SYSTEM “docinfo.dtd”-->
<pageinfo>

<page number=“1”>
<pageformat>PNG</pageformat>
<filename>readme_1.png</filename>
<path>/pbfolder/public</path>

Also, a file list file 426 is created when document 432 is opened and stored as document 418 on temporary storage 416. The file list file 426 preferably points to the locations of the image files 434, but also suitably points to the locations of edited copies of image files 420 for the document 432. The first file list file 426 created when document 432 is opened preferably points to at least one image file 434 on file storage 414, and points only to image files 434 on file storage 414. Preferably, the file list file 426 is a text file, although other types of files for storing information are suitably used as will be appreciated by one who is skilled in the art. The format of the file list file 426 of the presently preferred embodiment is illustrated below:

/pbfolder/public/readme_1.png
/pbfolder/public/readme_2.png
/pbfolder/public/readme_3.png
/pbfolder/public/readme_4.png
/pbfolder/public/readme_5.png

Once a document 432 is opened, copied, and stored as document 418 on temporary storage 416, the document 418 is suitably edited. When an edit is made, either by a user or through some automated process, the controller 412 suitably stores a copy of the edited page (image file) in temporary storage as image file 420. In addition, the controller 412 suitably generates an operation list file 428 comprising information about the edits made to the document 418; and an operation counter file 430 comprising a numerical value that is incremented each time an edit is made to the document 418. In the presently preferred embodiment, the operation list file 428 and the operation counter file 430 are suitably text files, although other types of files for storing information are suitably used as will be appreciated by one who is skilled in the art.

For example, if a user selects page 2 and page 3 of document 418 from a browser 404 and edits the pages to create an image shift, the operation list file 428 will suitably comprise information related to the particular edit made, and might suitably read:

Shift 2, 3.

It will be understood that the particular message format is not limiting. Any suitable indicator for a given operation is suitably used. For example, the word “shift” might correspond to an image shift of one-half inch to the right while “-shift” might correspond to an image shift of one-half inch to the left. Any code is suitably used to represent edits to a document wherein such code depends on the possible types of edits that can be made to a document and wherein the code is capable of specifically and uniquely identifying a change made to a document.

Assuming that the image shift was the first edit made to document 418, the operation counter file 430 might read:

1.

In order to properly track the locations of the edited images, another file list file 426 is suitably created. The second file list file might suitably read:

/pbfolder/public/readme_1.png
/temp /public/readme_2.png
/temp /public/readme_3.png
/pbfolder/public/readme_4 png
/pbfolder/public/readme_5.png

If a user were to again edit document 418 without undoing the first edit such that an invert function is performed on page 5, the operation list file 428 might then suitably read:

Shift 2, 3

Invert 5

In addition, the operation counter file 430 would suitably read:

2.

Furthermore, the third file list file 426 might suitably read:

/pbfolder/public/readme_1.png
/pbtemp/sessionlD; 6ofyk97uwl/public/readme_4_2 .png
/pbtemp/sessionlD; 6ofyk97uwl/public/readme_4_3.png
/pbfolder/public/readme_4.png
/pbtemp/sessionID; 6ofyk97uw1/public/readme_5_5.png

Because pages 1 and 4 have not been edited, the file list file points to the image files 434 for pages 1 and 4 on file storage 432, but points to copies of image files 420 for pages 2, 3 and 5 stored in temporary storage 416.

It is important to note that each consecutive file list file preferably does not overwrite the previous file list file 426. Also, each version of the file list file 426 is suitably correlated with the counter value of the operation counter file 430. This is suitably accomplished by including the counter value from the operation counter file 430 in the name of the file list file 426. In addition, a database, lookup tables, arrays, or the like are suitably used to properly correlate the file list files 426 with counter values as will be appreciated by one skilled in the art.

In order to execute an undo of an edit made to document 418, a user suitably executes an undo command, such as by selecting “undo” from a browser 404. In addition, the undo command is suitably received through automation means. The command is suitably sent through network interface 406, across data transport system 400 and to server 408 through network interface 410. Upon receipt of an “undo” command, the controller 412 suitably accesses the operation counter file 430 and decrements the counter value. After decrementing the counter value in the operation counter file 430, the controller 412 suitably accesses the file list file 426 that corresponds to the decremented counter value. From the file list file 426, the server suitably determines the location of the image files 434 and 420 at a time before which the counter was last incremented. Since the counter is incremented upon making an edit to the document 432, the files pointed to by the file list file 426 corresponding to the decremented counter represent the state of the document 418 prior to the last change made, effectively undoing the last change.

The temporary folder 416 and files stored therein therefore act as a historical buffer wherein edits to a document 432 can be undone. When the user ends the session, the temporary folder 416 and all files stored in the temporary folder 416 are preferably deleted, after which point a user could no longer undo changes made before ending the session.

All of the functionality of the present invention is suitably embodied in the system described, as well as in computer readable code on a computer readable medium for interfacing with files stored in file storage 414 and temporary storage 416. The computer readable code on a computer readable medium is preferably any code, embodied in software or hardware, for providing the functionality described in terms of the description of the present invention.

In the presently preferred embodiment, the computer readable code on a computer readable medium is at least one software component (“SC”) 438 stored in file storage 414, although the SC is also suitably stored in any storage accessible by the computer 402 and the controller 412. A “user” suitably invokes the functionality of at least one SC 438 to perform the functions described. It should be noted that the term “user” should be limited to a human user. A user is suitably anything capable of triggering a call to a SC, such as a computer-readable code used during automation. The at least one SC 438 then preferably interacts with the files stored in file storage 414 and temporary storage 416 to perform the functions described above.

The SC 414 is suitably computer-readable code written in any language. The SC 414 is preferably compiled, pre-written code that defines at least one interface that is callable to provide the functionality that the SC 414 encapsulates. SCs are typically packaged in “industry standard” ways such that they are callable from multiple languages, or from multiple environments. The computer-readable code, in the case of SCs is suitably a unit of independent deployment that has no persistent state. As such, it provides seamless integration with existing development tools, such Forte for Java or Microsoft Visual Studio. SCs are suitably used out-of-the-box, or extended and specialized by developers as desired. It should be noted that the SCs of the present invention are suitably designed for any language binding, such as Common Object Request Broker Architecture (“CORBA”), NET, COM, DCOM, C++, ActiveX, etc., as will be appreciated by those skilled in the art. In the presently preferred embodiment, the SC 414 is a C++ SC that is callable from multiple languages, or from multiple environments, or operating systems.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A system for implementing a pointer based historical buffer comprising:
storage means adapted for storage of data representative of an editable, electronic document;
display output means adapted for communicating data for generating a display of the electronic document to an associated display device;
data input means adapted to receive document modification data representative of a desired modification operation to be performed on the electronic document;
a pointer memory adapted for storing pointer information associated with received modification data;
pointer incrementing means adapted for incrementing a pointer value storage location of pointer information in accordance with each received modification data;
data editor means adapted for performing an edit to the electronic document in accordance with received document modification data;
association means adapted for associating each received document modification data with a pointer value associated therewith; and
historical document storage means adapted for storing at least a portion of the electronic document in the form prior to the most recent modification by the data editor.

2. The system of claim 1 wherein the data input means includes a plurality of networked data input devices, such that each of the plurality thereof is adapted to selectively perform edits on a commonly accessible electronic document by accessing a common pointer value storage location and a common historical document storage means.

3. The system of claim 1 wherein the historical document storage means is temporary, and includes means for purging the same after completion of an editing process of the electronic document.

4. The system of claim 3 wherein the historical document storage means is associated with at least one of a session identifier and a user identifier.

5. The system of claim 1 further comprising:
data input means adapted for receiving an undo command to selectively undo at least one previous edit; and
undo means adapted for selectively reversing edits to the electronic document by accessing the electronic documents stored in the historical documents storage means in accordance with an associated pointer value.

6. The system of claim 1 further comprising editing operation storage means for storage of selected information about editing operations performed on the electronic document.

7. The system of claim 1 wherein the pointer memory further stores pointer information associated with the electronic document.

8. The system of claim 1 further comprising document property information storage means adapted for storage of selected property information about the electronic document.

9. The system of claim 8 wherein the selected document property information is stored as a file in a format selected from markup language based files, flat files, text files, and database files.

10. The system of claim 8 wherein the document information storage means is temporary.

11. The system of claim 1 further comprising:
page information storage means adapted for storage of data representative of each page of the document and wherein the data representative of each page is stored in a separate file.

12. The system of claim 11 wherein the page information storage means is temporary.

13. The system of claim 11 further comprising page property information storage means adapted for storage of selected property information about each page, wherein the selected page property information is stored as a file in a format selected from markup language based files, flat files, text files, and database files.

14. The system of claim 1 wherein the system operates in a web-based environment.

15. A method for implementing a pointer based historical buffer comprising the steps of:
storing of data representative of an editable, electronic document in a selected storage area;
communicating data for generating a display of the electronic document to an associated display device;
receiving document modification data representative of a desired modification operation to be performed on the electronic document;
storing pointer information associated with received modification data in a pointer memory;
incrementing a point value storage area of pointer information in accordance with each received modification data;
performing an edit to the electronic document in accordance with received document modification data;
associating each received document modification data with a pointer value associated therewith; and
storing at least a portion of the electronic document in a form prior to the most recent modification thereof in a historical document storage area.

16. The method of claim 15 wherein a plurality of modifications are received from a plurality of networked data input devices, such that each of the plurality thereof is adapted to selectively perform edits on a commonly accessible electronic document by accessing a common pointer value storage location and a common historical document storage means.

17. The method of claim 15 wherein the historical document storage area is temporary, and includes means for purging the same after completion of an editing process of the electronic document.

18. The system of claim 17 wherein historical document storage area is associated with at least one of a session identifier and a user identifier.

19. The method of claim 15 further comprising the steps of:
receiving an undo command to selectively undo at least one previous edit; and
selectively reversing edits to the electronic document by accessing the electronic documents stored in the historical data storage means in accordance with an associated pointer value.

20. The method of claim 15 further comprising the step of storing selected information about editing operations performed on the electronic document in an editing operation storage area.

21. The method of claim 15 further comprising the step of storing pointer information associated with the electronic document in the pointer memory.

22. The method of claim 15 further comprising the step of storing selected property information about the electronic document in a document property storage area.

23. The method of claim 22 wherein the selected document property information is stored as a file in a format selected from markup language based files, flat files, text files, and database files.

24. The method of claim 22 wherein the document information storage area is temporary.

25. The method of claim 15 further comprising the steps of:
storing data representative of each page of the document in a page information storage area and wherein the data representative of each page is stored in a separate file.

26. The method of claim 25 wherein the page information storage area is temporary.

27. The method of claim 25 further comprising the step of storing selected property information about each page in a page property information area, wherein the selected page property information is stored as a file in a format selected from markup language based files, flat files, text files, and database files.

28. The method of claim 15 wherein the method operates in a web-based environment.

29. A computer readable medium of instructions for implementing a pointer based historical buffer comprising:
storage means adapted for storage of data representative of an editable, electronic document;
display out means adapted for communicating data for generating a display of the electronic document to an associated display device;
data input means adapted to receive document modification data representative of a desired modification operation to be performed on the electronic document;
a pointer memory adapted for storing pointer information associated with received modification data;
pointer incrementing means adapted for incrementing a pointer value storage location of pointer information in accordance with each received modification data;
data editor means adapted for performing an edit to the electronic document in accordance with received document modification data;
association means adapted for associating each received document modification data with a pointer value associated therewith; and
historical document storage means adapted for storing at least a portion of the electronic document in the form prior to the most recent modification by the data editor.

30. The computer-readable medium of instructions of claim 29 wherein the data input means includes a plurality of networked data input devices, such that each of the plurality thereof is adapted to selectively perform edits on a commonly accessible electronic document by accessing a common pointer value storage location and a common historical document storage means.

31. The computer-readable medium of instructions of claim 29 wherein-the historical document storage means is temporary, and includes means for purging the same after completion of an editing process of the electronic document.

32. The computer readable medium of instructions of claim 29 further comprising:
data input means adapted for receiving an undo command to selectively undo at least one previous edit; and
undo means adapted for selectively reversing edits to the electronic document by accessing the electronic documents stored in the historical documents storage means in accordance with an associated pointer value.

33. A computer implemented method for implementing a pointer based historical buffer comprising the steps of:
storing of data representative of an editable, electronic document in a selected storage area;
communicating data for generating a display of the electronic document to an associated display device;
receiving document modification data representative of a desired modification operation to be performed on the electronic document;
storing pointer information associated with received modification data in a pointer memory;
incrementing a point value storage area of pointer information in accordance with each received modification data;
performing an edit to the electronic document in accordance with received document modification data;
associating each received document modification data with a pointer value associated therewith; and
storing at least a portion of the electronic document in a form prior to the most recent modification thereof in a historical document storage area.

34. The computer implemented method of claim 33 wherein a plurality of modifications are received from a plurality of networked data input devices, such that each of the plurality thereof is adapted to selectively perform edits on a commonly accessible electronic document by accessing a common pointer value storage location and a common historical document storage means.

35. The computer implemented method of claim 33 wherein the historical document storage area is temporary, and includes means for purging the same after completion of an editing process of the electronic document.

36. The computer implemented method of claim 33 further comprising the steps of
receiving an undo command to selectively undo at least one previous edit; and
selectively reversing edits to the electronic document by accessing the electronic documents stored in the historical data storage means in accordance with an associated pointer value.
